(19) United States
(12) Patent Application Publication
(10) Pub. No.: US 2025/0380644 A1
(43) Pub. Date: Dec. 18, 2025

(54) DEVICE FOR A CHAIN DRIVE, CHAIN DRIVE AND BALER

(71) Applicant: DEERE & COMPANY, MOLINE, IL (US)

(72) Inventor: JEAN-LOUP CHASSIBOUD, Moulins (FR)

(21) Appl. No.: 19/089,219

(22) Filed: Mar. 25, 2025

(30) Foreign Application Priority Data
Jun. 17, 2024 (EP) 24182459.8

(51) Int. Cl. A01F 15/08; A01F 15/07; A01F 15/18; F16H 7/06

(52) U.S. Cl. CPC A01F 15/085; A01F 15/07; A01F 15/18; F16H 7/06

(57) ABSTRACT

An alignment device for a chain drive includes a bearing journal, a rotary bearing arranged on the bearing journal, and a sprocket guided on the rotary bearing. A first stop and a second stop are arranged on the bearing journal. The rotary bearing is freely movable on the bearing journal between the first stop and the second stop along an axial direction of the bearing journal. A chain drive including the alignment device and a round baler including such a chain drive are also proposed.

### CROSS-REFERENCE TO RELATED APPLICATIONS

This application claims the benefit of European Patent Application No. EP24182459.8, filed on Jun. 17, 2024, the disclosure of which is hereby incorporated by reference.

### TECHNICAL FIELD

The disclosure generally relates to a chain drive, particularly for a baler implement.

### BACKGROUND

Different implementations of a round baler are generally known, with a distinction being drawn between round balers having a fixed pressing chamber and round balers having a variable pressing chamber. Round balers having a fixed pressing chamber are distinguished by the fact that a plurality of pressing rollers are arranged over the circumference of a defined cylindrical pressing chamber and delimit the pressing space in a circumferential direction. The cylindrical pressing space is delimited at the end sides by respective side walls. By contrast, round balers having a variable pressing chamber are distinguished by the fact that the cylindrical pressing space is delimited in the circumferential direction by one or more pressing belts, with the pressing belt being guided over a plurality of rollers. The circumference of the pressing space is configured to be variable by changing the position of one or more rollers during the pressing operation. The cylindrical pressing space is likewise delimited at the end sides by respective side walls. It is also known to drive or rotate both the pressing rollers of a round baler having a fixed pressing chamber and the rollers of a round baler having a variable pressing chamber via a chain drive. Such chain drives are arranged on a frame of the round baler on one or both side walls outside of the pressing space. Here, the chain drive comprises a plurality of toothed wheels or sprockets which are connected to the pressing rollers or rollers, with the sprockets being drive-connected via one or more drive chains.

Such a round baler is known from DE 196 32 762 A1, for example. A drive device for the pressing rollers, which delimit a pressing chamber, of a round baler is shown therein, with a plurality of chain drives being provided. The individual chain drives each serve for driving some of the pressing rollers to be driven overall, with drive sprockets for driving the individual chain drives being able to be driven jointly. The sprockets intended for driving the pressing rollers are arranged on a circular arc in a lateral housing part of the round baler, and the chain drives are mounted parallel to one another.

A further round baler is shown in EP 2 952 089 A1, in which a plurality of pressing rollers are arranged around a pressing chamber and bear sprockets driven by a chain drive with a common chain. At least one of the sprockets and the associated pressing roller have interacting guide means, in the form of a shaft external toothing on the pressing roller and a hub internal toothing, interacting therewith, on the sprocket, which connect the sprocket and the pressing roller form-fittingly in a direction of rotation and allow a movement of the sprocket in the axial direction of the pressing roller. Also provided are means for fixing the axial position of the sprocket in the form of a shaft nut, which is fastened to the pressing roller stub, and an external toothing engaging therewith. The configuration of the pressing rollers and sprockets which is disclosed here is suitable for drive-transmitting sprockets, but proves to be cost-intensive and complicated to manufacture. However, it satisfies the requirement of axial adjustability of the sprockets for the purpose of fine adjustment within the chain drive.

In the case of the aforementioned chain drives, it is customary for the chain to be guided from a driving sprocket to the sprockets which are to be driven of the pressing rollers, with it being necessary, on the one hand, to guide the chain with a plurality of windings and loop-like arrangements of the chain, in particular to allow pivoting of the pressing rollers in order to open the pressing chamber. On the other hand, such a chain drive has to be kept tensioned. To make this possible, a chain drive of the aforementioned type has, in addition to the sprockets to be driven, further sprockets arranged therein which, within the chain drive, for the purpose of the aforementioned chain guidance, serve as deflection sprockets or guide sprockets and/or as sprockets for tensioning the chain drive. These further sprockets must also be subject to axial final adjustment in order to lie precisely in the run of the chain. The fine adjustment of the sprockets mounted on the bearing journals usually occurs by means of spacer disks or spacers which are mounted on both sides of the end sides of the rotary bearing on the bearing journal, as is known, for example, from the mountings of the chain drives on a John Deere round baler of the F441R type. This method of axial fine adjustment often proves to be very time-consuming and can occasionally require the multiple mounting and demounting of the sprocket on the bearing journal. The application of the above-described solution for fine adjustment of driven sprockets is unsuitable or not practicable for a sprocket guided on a rotary bearing.

### SUMMARY

The present disclosure is therefore based on the object of proposing an alignment device for a chain drive, a chain drive and a baler by means of which the aforementioned problems are overcome. In particular, an alignment device for a chain drive, a chain drive and a baler shall be proposed which make it possible to carry out an axial fine adjustment in a structurally simple manner.

According to the disclosure, an alignment device for a chain drive is proposed, in particular an alignment device for adjusting a sprocket of a chain drive of a baler. The alignment device comprises a bearing journal, a rotary bearing arranged on the bearing journal, and a sprocket guided on the rotary bearing. The bearing journal can in particular comprise a free end and a fixed end. On the bearing journal there is arranged a first stop, in particular on the fixed end of the bearing journal, and a second stop, in particular on the free end. The bearing journal can in particular comprise the first and second stops. Specifically, the first and/or the second stop can be designed as a component or part of the bearing journal. The rotary bearing is arranged between the first stop and the second stop. The rotary bearing is freely movable, preferably mounted in a freely movable manner, on the bearing journal between the first and second stops along an axial direction of the bearing journal or in an axial direction of the bearing journal. In other words, the rotary bearing is mounted on the bearing journal in a floating manner between the first and second stops along an axial direction of the bearing journal or in an axial direction of the bearing journal.

An axial fine adjustment of the rotary bearing or of the sprocket and a spacer disk or spacer element may be omitted. Therefore, no spacer element is provided in particular between the first and/or second stop and the rotary bearing. Advantageously, a complex setting of the sprocket or the rotary bearing on the bearing journal with spacer elements is thus omitted. Owing to the floating mounting, the rotary bearing or the sprocket aligns itself, and a spacer element can be omitted.

In an embodiment of the disclosure, the rotary bearing comprises a first end face and/or a second end face. A first distance between the first and second stops, in particular along the axial direction on the rotary bearing, minus a second distance between the first and second end faces, which can in particular be the smallest or direct distance between the first and second end faces, is ≥6 mm, preferably >8 mm, particularly preferably ≥10 mm. The second distance can correspond to the width of the rotary bearing.
Therefore, A₁-A₂≥6 mm.
Wherein: A₁=first distance, and A₂=second distance.

In other words, the sum of a third distance, in particular in an axial or along the axial direction of the bearing journal, between the first end face and the first stop and a fourth distance, in particular in an axial direction of the bearing journal, between the second end face and the second stop is ≥6 mm, preferably ≥8 mm, particularly preferably ≥10 mm.
Therefore, A₃+A₄≥6 mm.
Wherein: A₃=third distance, and A₄=fourth distance.

The first end face can face the first stop and/or in particular the fixed end of the bearing journal, and the second end face can face the second stop and/or in particular the free end of the bearing journal. Advantageously, it is thereby possible for the rotary bearing to be mounted in a floating manner and/or freely movable, preferably mounted in a freely movable manner, on at least 6 mm on the bearing journal between the first and second stops along an axial direction of the bearing journal or in an axial direction of the bearing journal.

In an embodiment of the disclosure, the first stop is formed and/or arranged on the fixed end of the bearing journal, and/or the second stop is formed and/or arranged on the free end of the bearing journal. Specifically, the first stop can be designed as part of the bearing journal, and/or the second stop can be designed as part of the bearing journal. Alternatively or additionally, the first and/or second stop can be arranged as components on the bearing journal. The first stop can be formed by the component itself supporting the bearing journal.

In an embodiment of the disclosure, the first stop comprises a shaft shoulder or is designed as a shaft shoulder. The shaft shoulder can be formed and/or arranged on the bearing journal between the rotary bearing and the fixed end and/or worked into the bearing journal. The first stop can likewise comprise a snap ring. The snap ring can be held in an annular groove formed on the bearing journal between the rotary bearing and the fixed end.

In an embodiment of the disclosure, the first stop comprises a first threaded nut. The first stop can in particular be designed as a first threaded nut.

A first external thread is formed and/or arranged on the bearing journal between the rotary bearing and the fixed end of the bearing journal. Specifically, the first external thread can be formed and/or arranged on the fixed end of the bearing journal. The first external thread can be designed as part of the bearing journal, in particular as an integral component of the bearing journal. The first threaded nut is arranged on the first external thread, preferably connected thereto, particularly preferably connected thereto rotatably and releasably.

Advantageously, an adjustable first stop can thereby be provided, as a result of which the axial adjustment travel of the rotary bearing or sprocket is additionally variable by adjusting the first threaded nut, in particular the first and/or third distance along the axial direction between the first and second stops is adjustable or variable.

In an embodiment of the disclosure, the second stop comprises a clamping plate. The second stop can in particular be designed as a clamping plate. The clamping plate is arranged on, in particular fastened to, the free end of the bearing journal. Moreover, the bearing journal can comprise an internal threaded region and/or an internal thread. The internal threaded region and/or the internal thread can be designed as part of the bearing journal and/or be arranged therein. The clamping plate can be connected to or by a clamping screw to the internal threaded region and/or to the internal thread and thus to the bearing journal, in particular fastened thereto. The rotary bearing is freely movable on the bearing journal in the axial direction between the clamping plate and the first stop. Specifically, the first distance between the first stop and the clamping plate minus the second distance can be ≥6 mm, preferably ≥8 mm, particularly preferably ≥10 mm. In other words, the sum of the third distance and a fourth distance, in particular in an axial direction of the bearing journal, between the second end face and the holding plate is ≥6 mm.

In an embodiment of the disclosure, the second stop comprises a second threaded nut. The second stop can in particular be designed as a second threaded nut.

A second external thread is formed and/or arranged on the free end of the bearing journal. The second external thread can be designed as part of the bearing journal, in particular as an integral component of the bearing journal. The second threaded nut is arranged on the second external thread, preferably connected thereto, particularly preferably connected thereto rotatably and releasably. The rotary bearing can thereby be freely movable on the bearing journal in an axial direction between the second threaded nut and the first stop, i.e., is in particular mounted in a floating manner. Advantageously, an adjustable second stop can thereby be provided, as a result of which the axial adjustment travel of the rotary bearing or sprocket is additionally variable by adjusting the threaded nut, in particular the second and/or fourth distance along the axial direction between the first and second stops is adjustable or variable.

In an embodiment of the disclosure, the diameter of the first external threaded region is greater than the diameter of the second external threaded region. The second external threaded region can be formed on the free end of the bearing journal, and/or the first external threaded region can be formed on the fixed end. Specifically, the second external threaded region can be formed, in particular extend, from the free end of the bearing journal, and the first external threaded region can be formed, in particular extend, between the fixed end and the rotary bearing. Different diameters of the external threaded regions, starting from a smaller diameter at the free end of the bearing journal, allow mounting of the alignment device solely through access to the free end of the bearing journal. This makes possible a non-removable fastening of the fixed end of the bearing journal, for example to the frame of the baler, for example by a welded connection or as a cast or forged part of a frame part of the frame. A bearing journal region without a thread, on which the rotary bearing is held, is preferably provided between the external threaded regions. The bearing journal region on which the rotary bearing is held can thus be manufactured independently of the external threaded regions and with sizes of diameter differing therefrom and can be adapted to an optimal snug fit for the rotary bearing.

The above-described alignment device is particularly suitable for use in a chain drive for driving pressing rollers or pressing belts of a baler or round baler for pressing crops. Here, the alignment device can be used on one or more sprockets of the chain drive.

The disclosure also relates to a baler having a chain drive. The baler can be designed as a round baler. In an embodiment of the disclosure, the baler comprises a frame, a pressing space and pressing rollers or pressing belts, which are arranged on the frame and surround the pressing space, for pressing crops. The pressing rollers or the pressing belt can be driven using the chain drive described above. The chain drive can be arranged on the frame and/or connected thereto, in particular fastened thereto. The aforementioned chain drive is able to be used in a wide variety of types of agricultural machines in which rolls, rollers, drums or other rotating bodies have to be driven. However, it is particularly suitable for use in a baler or round baler. The chain drive can be arranged on the frame and/or a side wall of the baler or round baler to drive the pressing rollers or the pressing belt.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a baler according to the disclosure, having a chain drive according to the disclosure for driving pressing rollers.

FIG. 2 is a schematic diagram of an exemplary embodiment of an alignment device for the chain drive of FIG. 1.

FIG. 3 is a schematic diagram of an alternative form of the alignment device for the chain drive of FIG. 1.

FIG. 4 is a schematic diagram of a further alternative form of the alignment device for the chain drive of FIG. 1.

FIG. 5 is a schematic diagram of a further alternative form of the alignment device for the chain drive of FIG. 1.

FIG. 6 is a schematic diagram of a further alternative form of the alignment device for the chain drive of FIG. 1.

FIG. 7 is a schematic diagram of a further alternative form of the alignment device for the chain drive of FIG. 1.

FIG. 8 is a schematic diagram of a further alternative form of the alignment device for the chain drive of FIG. 1.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

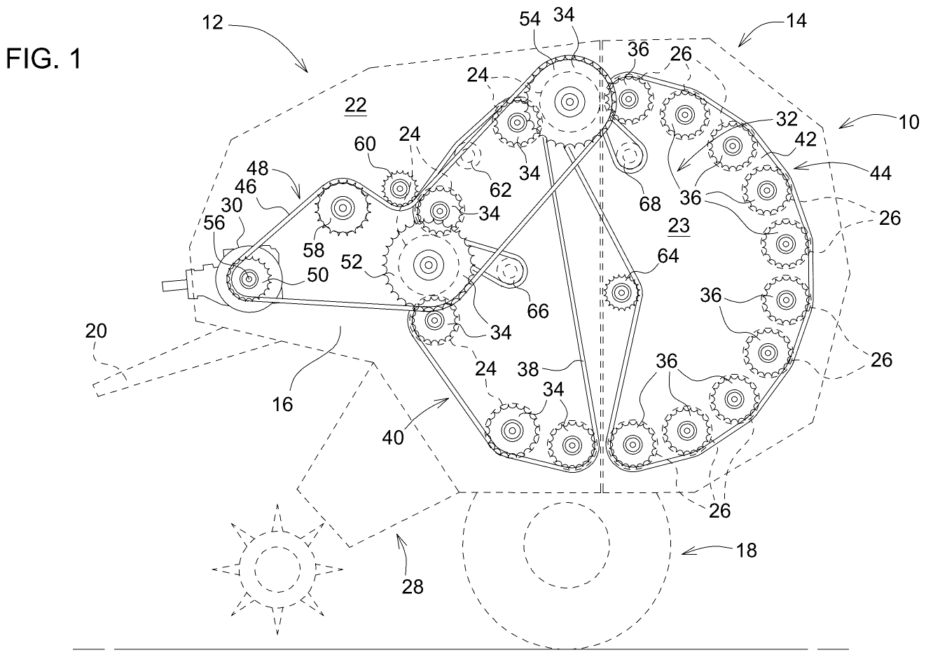

Referring to the Figures, wherein like numerals indicate like parts throughout the several views, a baler is generally shown at 10 in FIG. 1. The baler 10, which in the example implementation described herein is in particular designed as a round baler. The baler 10 has a front part 12 and a rear part 14. The baler 10 further comprises a frame 16, a chassis 18, a drawbar 20, side walls 22 on the front part 12, side walls 23 on the rear part 14, pressing rollers 24 on the front part 12, pressing rollers 26 on the rear part 14, a feed assembly 28 for holding a crop, and a drive device 30. The frame 16 consists of struts and the like which hold together and support the aforementioned components and thus form the front part 12 into a unit. The chassis 18 is composed, in a manner which is not indicated in more detail, of an axle and of wheels which are mounted thereon and are situated in the lower rear region of the front part 12 and support the entire baler 10 such that it can move on the ground. The drawbar 20 serves for connecting the baler 10 to a towing vehicle, for example to an agricultural tractor, and is fixedly connected to the frame 16.

The side walls 22, 23 are also fixedly connected to the frame 16 and terminate a pressing chamber 32 at the end. For this purpose, the side walls 22, 23 assume a distance from one another and movably hold the pressing rollers 24 and 26. In the upper rear region of the front part 12 there is provided a bearing (not shown) which serves for the vertically pivotable connection of the rear part 14. The side walls 22, 23 are connected to one another by cross-struts, which are not indicated in further detail but are well known.

The pressing rollers 24 and 26 are composed in a known manner of a sheet-metal shell and of a shaft or shaft stubs. The center points of the pressing rollers 24 and 26, that is to say their axes of rotation, are situated substantially on a part of a circle which surrounds the pressing chamber 32. On at least one side of the baler 10, on the outer side of the side walls 22, 23, sprockets 34 are provided on the pressing rollers 24 on the front part 12, and sprockets 36 are provided on the pressing rollers 26 on the rear part 14. The sprockets 34 of the pressing rollers 24 are surrounded by a drive chain 38 of a first chain drive 40. The sprockets 36 of the pressing rollers 26 are surrounded by a drive chain 42 of a second chain drive 44. A further drive chain 46 of a third chain drive 48 serves for driving the first and second chain drives 40 and 44. The third chain drive 48 is driven by a main drive sprocket 50 which is connected to the drive device 30. The third chain drive 48 drives a first drive sprocket 52 which serves for driving the first chain drive 40. The third chain drive 48 additionally also drives a second drive sprocket 54 which serves for driving the second chain drive 44. The first and second drive sprockets 52 and 54 are each double-toothed, with a first toothing of the first drive sprocket 52 and a first toothing of the second drive sprocket 54 being connected to the third chain drive 48. A second toothing of the first drive sprocket 52 is connected to the first chain drive 40 and drives the same. A second toothing of the second drive sprocket 54 is connected to the second chain drive 44 and drives the same.

The drive device 28 is, in a manner which has not been shown, fed by the towing vehicle, for example via a power take-off shaft, and contains a transversely extending shaft 56 in the rear region of the drawbar 20. Emanating from the shaft 56 is the main drive sprocket 50 which drives the third chain drive 48. The chain drives 40, 44 and 48 are guided over additional sprockets 58, 60, 62, 64 and tensioned by means of tensioning devices, which are not indicated in more detail. Furthermore, a sprocket 66 is provided for the first chain drive 40 and a sprocket 68 is provided for the second chain drive 44 for guiding or deflecting the respective drive chains 38, 42. A baler with pressing belts can comprise an alternative arrangement of chain drives 40, 44, 48.

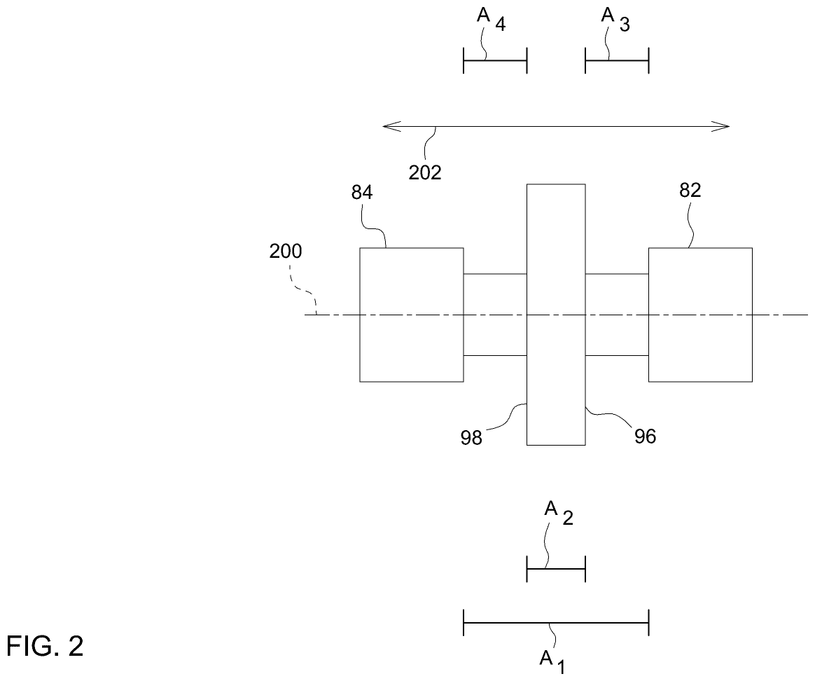

The baler 10 comprises an alignment device 70 for a chain drive 40, 44, 48, in particular a alignment device for adjusting a sprocket 58, 60, 62, 64, 66, 68 of a chain drive 40, 44, 48. The chain drive 40, 44, 48 can likewise comprise the alignment device 70 for driving pressing rollers 24, 26 or pressing belts of the baler 10. The alignment device 70 is described in detail in FIGS. 2 to 8. The alignment device 70 comprises a bearing journal 72, a rotary bearing 74 arranged on the bearing journal 72, and a sprocket 58, 60, 62, 64, 66, 68 guided on the rotary bearing 74. A first stop 82 and a second stop 84 are arranged and/or formed on the bearing journal 72. The bearing journal 72 comprises a free end 76 and a fixed end 78. The latter can be fastened to the frame 16, to the side walls 22, 23 or to a tensioning arm 80 of a tensioning device (not indicated in more detail). The fastening of the bearing journal 72 can be made in a removable (releasable) manner in any desired form or in a non-releasable manner, for example by means of welding or by means of a connection produced in the casting or forging process of the tensioning arm 80. The first stop 82 can be arranged on the fixed end of the bearing journal 76 and/or the second stop 84 can be arranged on the free end 78 of the bearing journal 72 and/or formed as a component of the bearing journal 72.

The rotary bearing 74 is freely movable, in particular mounted in a freely movable manner, on the bearing journal 72 between the first stop 82 and the second stop 84 along an axial direction 202 of the bearing journal 72. The axial direction 202 can point or be oriented in the direction of and/or parallel to a longitudinal axis 200 of the bearing journal 72. The rotary bearing 74 can have a first end face 96 and/or a second end face 98. A first distance A₁ between the first and second stops 82, 84 minus a second distance A₂ between the first and second end faces 96, 98 can be ≥6 mm, preferably ≥8 mm, particularly preferably ≥10 mm, so that the rotary bearing 74 is freely movable on the bearing journal 72 between the first stop 82 and the second stop 84 along the axial direction 202 of the bearing journal 72. In other words, the sum of a third distance A₃ between the first end face 96 and the first stop 82 and a fourth distance A₄ between the second end face 98 and the second stop 84 can be ≥6 mm, preferably ≥8 mm, particularly preferably ≥10 mm.

The first and second stops 82, 84 can be designed and/or arranged in different ways, as shown in FIGS. 2 to 8. FIGS. 2 to 8 show schematic diagrams of different exemplary embodiments of the alignment device 70 according to the disclosure. The alignment devices 70 shown in FIGS. 2 to 8 are substantially identical but at least similar, and therefore only details and/or differences are discussed below. The baler 10 shown in FIG. 1 and/or the chain drive 40, 44, 48 can comprise the alignment device 70 shown in FIGS. 2 to 8.

According to FIGS. 2: A₁-A₂ ≥6 mm. Wherein A₁=first distance, and A₂=second distance.

Additionally, according to FIG. 2, A₃+A₄≥6 mm. Wherein A₃=third distance, and A₄=fourth distance.

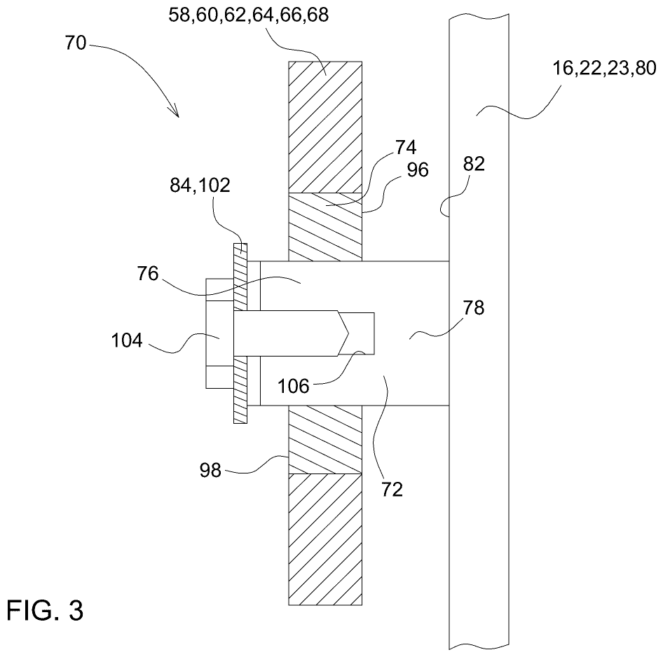

According to FIG. 3, the first stop 82 is formed by the component supporting the bearing journal, here the frame 16 or the side walls 22, 23 or the tensioning arm 80 of a tensioning device.

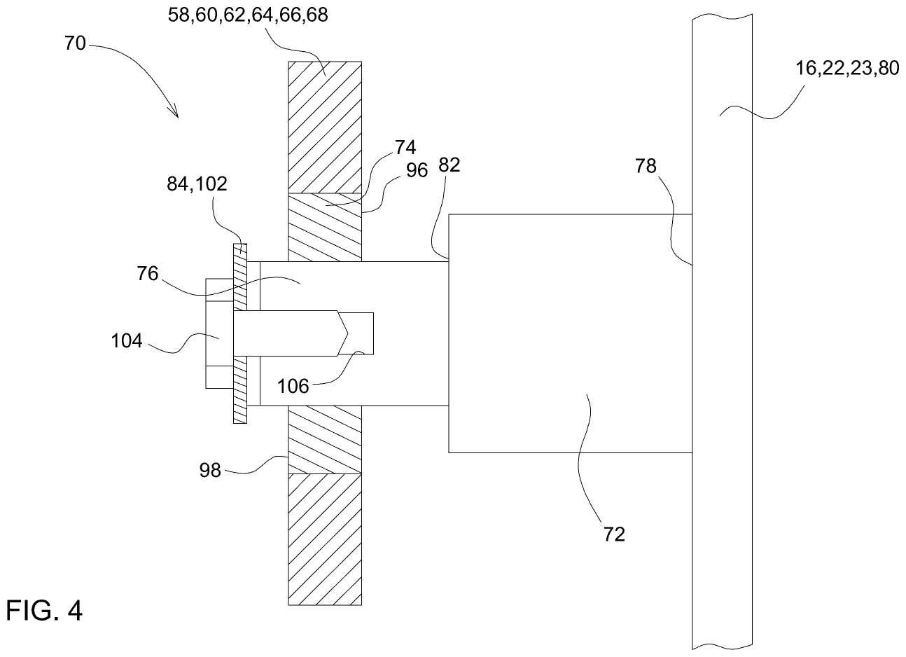

According to FIG. 4, the first stop 82 can be formed by a shaft shoulder 84. The shaft shoulder 84 can be arranged on the bearing journal 72. The bearing journal 72 can likewise be formed in particular at least partially as a shaft shoulder 84 or be formed by a shaft shoulder 84 formed on the bearing journal 72.

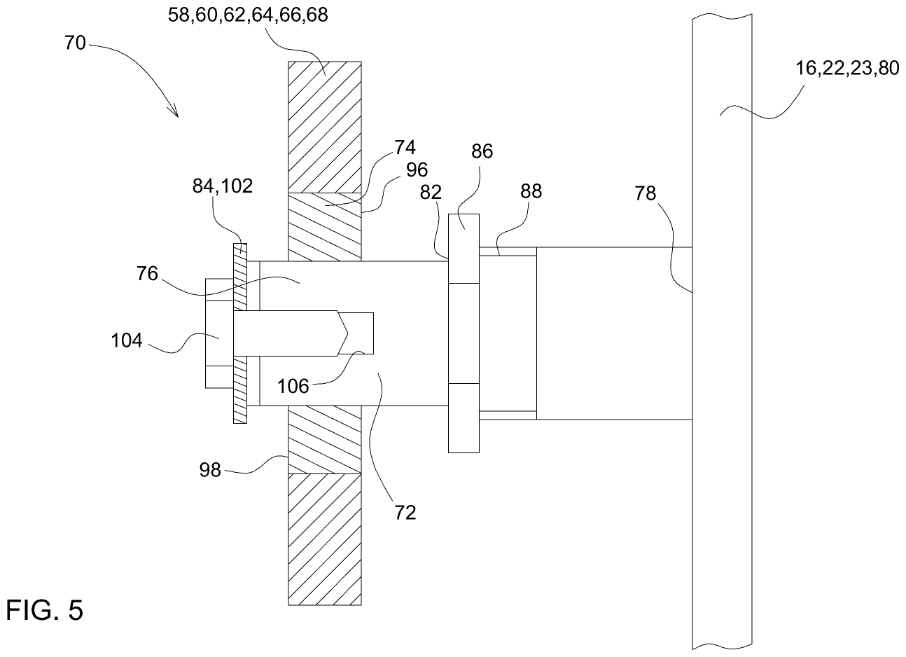

According to FIG. 5, the first stop 82 is formed by a first threaded nut 86 which is guided on a first external threaded region 88 on the bearing journal 72 between the rotary bearing 74 and the fixed end 78 of the bearing journal 72.

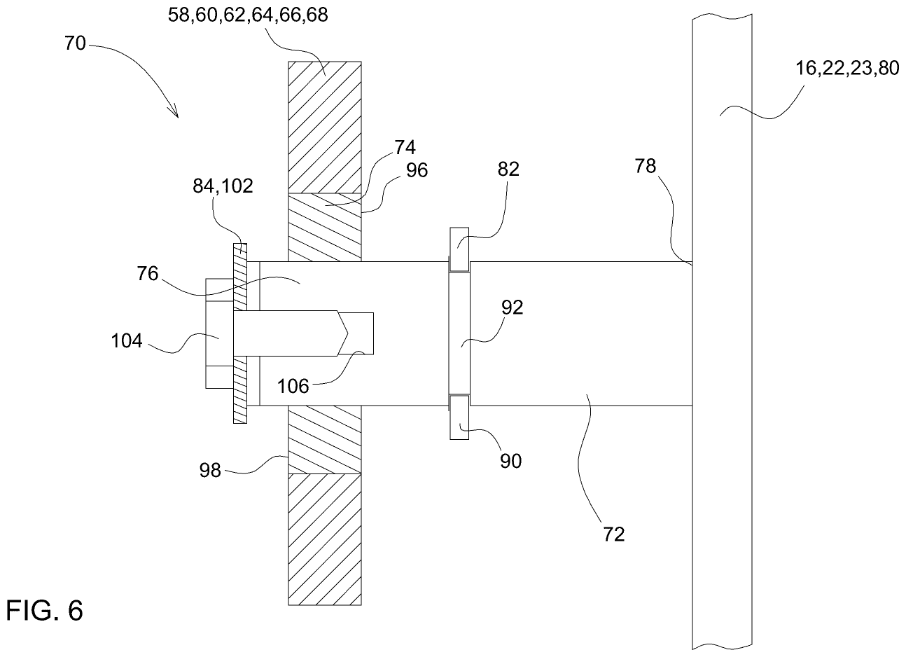

According to FIG. 6, the first stop 82 is formed by a snap ring 90 which is guided in an annular groove 92 on the bearing journal 72 between the rotary bearing 74 and the fixed end 78 of the bearing journal 72.

According to FIGS. 3 to 6, the second stop 84 is formed as a clamping plate 102, wherein the rotary bearing 74 is freely movable on the bearing journal 72 in an axial direction between the clamping plate 102 and the first stop 82. The clamping plate 102 is fastened to the free end of the bearing journal 72. The bearing journal 72 also comprises an internal threaded region and/or an internal thread 106 to which the clamping plate 102 is fastened via a clamping screw 104. Specifically, the clamping screw 104 can be guided in the internal thread 106 formed on the free end 76 of the bearing journal 72.

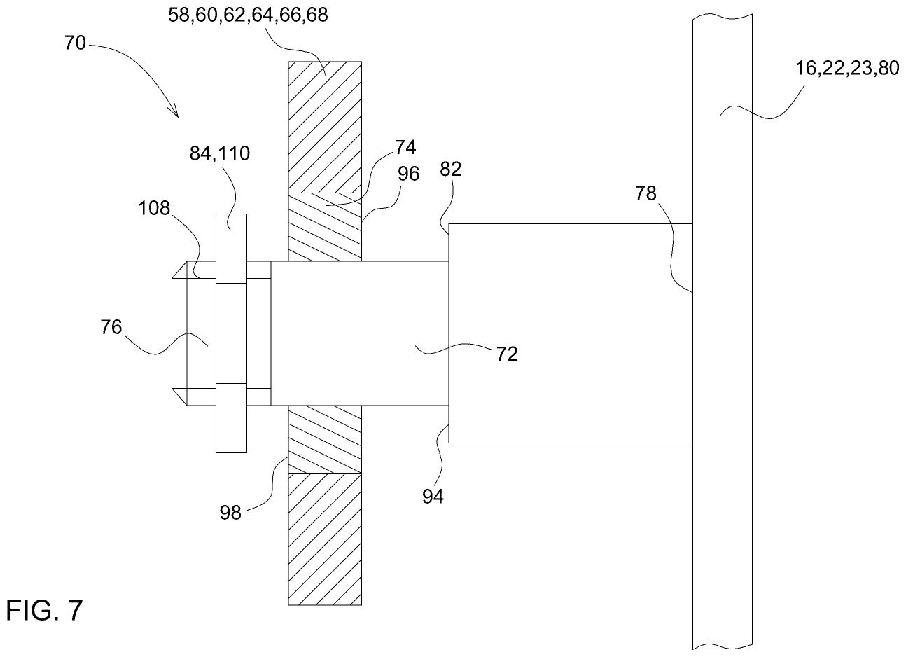

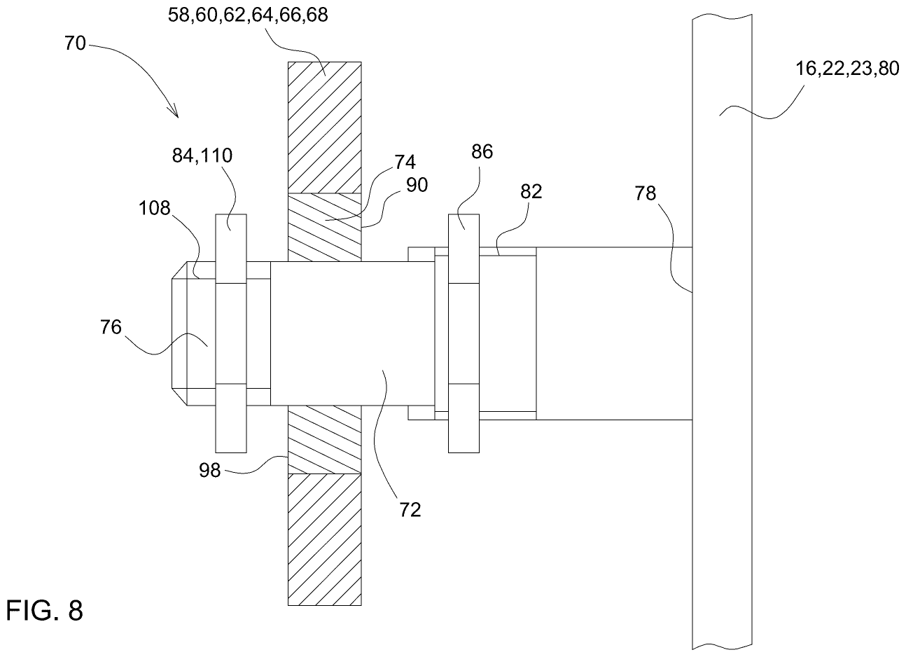

In an alternative embodiment, which is shown in FIGS. 7 and 8, the second stop 84 can comprise a second threaded nut 110, which is arranged on a second external thread 108 formed on the free end 76 of the bearing journal 72. The second external thread 108 interacting with the second threaded nut 110 has the same technical effect as the above-described internal thread 106, the clamping screw 104 and the clamping plate 102 of FIGS. 3 to 6. In FIG. 8, the alignment device 70 comprises the first and second external threaded regions 82, 84 formed on the bearing journal 72, or the first and second external threaded regions 82, 84 are designed as part of the bearing journal 72. The diameter of the first external threaded region 82 is greater than the diameter of the second external threaded region 84. By rotating the first and second threaded nuts 86, 88 or the first threaded nut 86 and the clamping screw 104, the position of the rotary bearing 74 can be changed axially relative to the bearing journal 72, and thus the distances can be set and/or adjusted.

As shown in FIGS. 2 to 8, the rotary bearing 74 is freely movable, in particular mounted in a floating manner, in an axial direction between the first stop 82 and the second stop 84. Depending on requirements, the rotary bearing 74 can be moved and/or adjusted axially in one or the other direction along the bearing journal 72, wherein the first and/or third and/or fourth distance is variable. Overall, an axial adjustment of the rotary bearing 74 and/or of the sprocket 58, 60, 62, 64, 66, 68 is thereby made possible.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. An alignment device for a chain drive of a baler, the alignment device comprising:
a bearing journal, a rotary bearing arranged on the bearing journal, and a sprocket, guided on the rotary bearing;
a first stop and a second stop being arranged on the bearing journal; and
wherein the rotary bearing is freely movable on the bearing journal between the first stop and the second stop along an axial direction of the bearing journal.

2. The alignment device set forth in claim 1, wherein the rotary bearing includes a first end face and an opposing second end face, and wherein a first distance between the first stop and the second stop minus a second distance between the first end face and the second end face is equal to or greater than six millimeters.

3. The alignment device set forth in claim 1, wherein the first stop is formed on a fixed end of the bearing journal, and the second stop is formed on a free end of the bearing journal.

4. The alignment device set forth in claim 3, wherein the first stop includes a shaft shoulder which is formed on the bearing journal between the rotary bearing and the fixed end.

5. The alignment device set forth in claim 1, wherein the first stop includes a snap ring which is held in an annular groove formed on the bearing journal between the rotary bearing and a fixed end of the bearing journal.

6. The alignment device set forth in claim 1, wherein the first stop includes a first threaded nut which is arranged on a first external thread formed on the bearing journal between the rotary bearing and a fixed end of the bearing journal.

7. The alignment device set forth in claim 6, wherein the second stop includes a clamping plate arranged on a free end of the bearing journal, wherein the rotary bearing is freely movable on the bearing journal in an axial direction between the clamping plate and the first stop.

8. The alignment device set forth in claim 7, wherein the bearing journal includes an internal threaded region to which the clamping plate is connected via a clamping screw.

9. The alignment device set forth in claim 6, wherein the second stop includes a second threaded nut, which is arranged on a second external thread formed on the free end of the bearing journal, and the rotary bearing is freely movable on the bearing journal in an axial direction between the second threaded nut and the first stop.

10. The alignment device set forth in claim 9, wherein the diameter of the first external threaded region is greater than the diameter of the second external threaded region.

11. A baler for forming round bales, the baler comprising:
a frame;
a pressing space;
one of a plurality of pressing rollers or at least one pressing belt, wherein the plurality of pressing rollers or the at least one pressing belt are arranged on the frame and surround the pressing space for pressing crops;
wherein the plurality of pressing rollers or the at least one pressing belt are driven by a chain drive including a chain, a sprocket engaged with the chain, and an alignment device for aligning the chain and the sprocket, wherein the alignment device includes:
a bearing journal, a rotary bearing arranged on the bearing journal and supporting the sprocket;
a first stop and a second stop being arranged on the bearing journal on opposing sides of the rotary bearing; and
wherein the rotary bearing is freely movable on the bearing journal between the first stop and the second stop along an axial direction of the bearing journal.

12. The baler set forth in claim 11, wherein the rotary bearing includes a first end face and an opposing second end face, and wherein a first distance between the first stop and the second stop minus a second distance between the first end face and the second end face is equal to or greater than six millimeters.

13. The baler set forth in claim 11, wherein the first stop is formed on a fixed end of the bearing journal, and the second stop is formed on a free end of the bearing journal.

14. The baler set forth in claim 13, wherein the first stop includes a shaft shoulder which is formed on the bearing journal between the rotary bearing and the fixed end.

15. The baler set forth in claim 11, wherein the first stop includes a snap ring which is held in an annular groove formed on the bearing journal between the rotary bearing and a fixed end of the bearing journal.

16. The baler set forth in claim 11, wherein the first stop includes a first threaded nut which is arranged on a first external thread formed on the bearing journal between the rotary bearing and a fixed end of the bearing journal.

17. The baler set forth in claim 16, wherein the second stop includes a clamping plate arranged on a free end of the bearing journal, wherein the rotary bearing is freely movable on the bearing journal in the axial direction between the clamping plate and the first stop.

18. The baler set forth in claim 17, wherein the bearing journal includes an internal threaded region to which the clamping plate is connected to the bearing journal via a clamping screw.

19. The baler set forth in claim 18, wherein the second stop includes a second threaded nut, which is arranged on a second external thread formed on the free end of the bearing journal, and the rotary bearing is freely movable on the bearing journal in an axial direction between the second threaded nut and the first stop.

20. The baler set forth in claim 19, wherein the diameter of the first external threaded region is greater than the diameter of the second external threaded region.
